(19) United States
(12) Patent Application Publication
(10) Pub. No.: US 2026/0258967 A1
(43) Pub. Date: Sep. 3, 2026

(54) Silencing Assembly, Expansion Valve, and Air Conditioning System

(71) Applicant: ZHEJIANG DUNAN ARTIFICIAL ENVIRONMENT CO., LTD., Shaoxing, Zhejiang (CN)

(72) Inventors: Yuchen HE, Shaoxing, Zhejiang (CN); Chao JIANG, Shaoxing, Zhejiang (CN); Guanjun XU, Shaoxing, Zhejiang (CN); Tonghui LIU, Shaoxing, Zhejiang (CN)

(73) Assignee: ZHEJIANG DUNAN ARTIFICIAL ENVIRONMENT CO., LTD., Shaoxing, Zhejiang (CN)

(21) Appl. No.: 18/877,610

(22) PCT Filed: May 30, 2023
(86) PCT No.: PCT/CN2023/097214

§ 371 Date: Dec. 20, 2024

(30) Foreign Application Priority Data
Jun. 20, 2022 (CN) 202210700307.7
May 24, 2023 (CN) 202310598231.6

(51) Int. Cl. F24F 13/24; F25B 41/31

(52) U.S. Cl. CPC F24F 13/24; F25B 41/31; F25B 2500/12

(57) ABSTRACT

Some embodiments of the present disclosure provide a silencing assembly, an expansion valve, and an air conditioning system. The silencing assembly comprises a muffling block group. The muffling block group comprises a plurality of muffling channels and one or a plurality of first passage channels, wherein the sectional circulation area of the first passage channel is greater than the minimum sectional circulation area in the plurality of muffling channels. The present disclosure solves the problem of reduction in system reliability due to a silencing structure of an electronic expansion valve in the prior art being easily blocked by impurities.

The present disclosure is a national stage disclosure of International Patent Disclosure No. PCT/CN2023/097214 which is filed on May 30, 2023, and claims priority to Patent Disclosure No. 202210700307.7, filed on Jun. 20, 2022, and entitled “SILENCING ASSEMBLY, EXPANSION VALVE, AND AIR CONDITIONING SYSTEM”, and claims priority to Patent Disclosure No. 202310598231.6, filed on May 24, 2023, and entitled “SILENCING ASSEMBLY, EXPANSION VALVE, AND AIR CONDITIONING SYSTEM”, and the contents of which are hereby incorporated by reference in its entirety.

### TECHNICAL FIELD

The present disclosure relates to the field of the silencing technology of electronic expansion valves, specifically to a silencing assembly, an expansion valve, and an air conditioning system.

### BACKGROUND ART

At present, during the use of an electronic expansion valve, due to the unstable flow of a two-phase fluid, the sizes of bubbles before or after throttling are inconsistent. As a result, discontinuous noise is easily caused, and the level of noise is higher.

In the prior art, a silencing structure is usually arranged on an electronic expansion valve, the silencing structure comprises a plurality of pores, and a refrigerant achieves a muffling effect during the process of flowing through the plurality of pores.

However, due to smaller pore sizes of the pores in the silencing structure, during the process of the refrigerant flowing through the silencing structure, impurities in the refrigerant easily block the pores, which affect the muffling effect and the performance reliability of the long-term operation of a system.

### SUMMARY OF THE INVENTION

The main purpose of the present disclosure is to provide a silencing assembly, an expansion valve, and an air conditioning system to solve the problem of reduction in system reliability due to a silencing structure of an electronic expansion valve in the prior art being easily blocked by impurities.

In order to achieve the above purpose, according to a first aspect of the present disclosure, a silencing assembly is provided. The silencing assembly includes: a muffling block group, the muffling block group includes a plurality of muffling channels and at least one first passage channel, and the sectional circulation area of the first passage channel is greater than the minimum sectional circulation area in the plurality of muffling channels.

In some embodiments, the muffling block group includes a silencing group body, and the at least one first passage channel and the plurality of muffling channels are arranged in the silencing group body.

In some embodiments, the muffling block group includes a silencing group body and a support frame, the silencing group body is arranged on the support frame, the at least one first passage channel is arranged in the support frame, and the plurality of muffling channels are arranged in the silencing group body.

In some embodiments, the muffling block group further includes: a first muffling block and a second muffling block which are arranged at an interval along a flow direction of a fluid, the first muffling block and the second muffling block are both provided with the plurality of muffling channels; and the first muffling block and/or the second muffling block is provided with a plurality of first passage channels.

In some embodiments, the minimum vertical distance between the first muffling block and the second muffling block ranges from 0.6 mm to 5 mm.

In some embodiments, the first muffling block includes: multiple layers of first filter screens which are stacked in sequence, the number of layers of the first filter screen is 3-8, and the number of meshes of the first filter screen is 50-90.

In some embodiments, the second muffling block includes: multiple layers of second filter screens which are stacked in sequence, the number of layers of the second filter screen is 3-8, and the number of meshes of the second filter screen is 50-90.

In some embodiments, the muffling block group further includes: a silencing group body, the plurality of first passage channels and the plurality of muffling channels are arranged on the silencing group body; and a support frame, the support frame is provided with a plurality of second passage channels, the plurality of second passage channels are arranged at intervals, and the muffling block group is arranged on the support frame.

In some embodiments, the radial section of the second passage channel extends along an arc trajectory; or the radial section of the second passage channel is circular; or the silencing group body includes: a first muffling block which is arranged on a first side of the support frame, and a second muffling block which is arranged on a second side of the support frame, the projection area of an orthographic projection of the first muffling block is greater than the projection area of an orthographic projection of the second muffling block, or the orthographic projection of the first muffling block is overlapped with the orthographic projection of the second muffling block; the first muffling block and the second muffling block are both provided with the plurality of muffling channels; and the first muffling block is provided with the at least one first passage channel.

In some embodiments, the muffling block group includes a silencing group body and a support frame; the silencing group body includes: a first muffling block which is arranged on a first side of the support frame, and a second muffling block which is arranged on a second side of the support frame, the projection area of an orthographic projection of the first muffling block is greater than the projection area of an orthographic projection of the second muffling block, or the orthographic projection of the first muffling block is overlapped with the orthographic projection of the second muffling block; the first muffling block and the second muffling block are both provided with the plurality of muffling channels; and the first muffling block is provided with the at least one first passage channel

In some embodiments, the first muffling block is provided with the at least one first passage channel, and at least part of each of the first passage channels on the first muffling block is opposite to the plurality of muffling channels on the second muffling block.

In some embodiments, the support frame includes: a support body which is provided with a mounting opening, a plurality of second passage channels are arranged around the mounting opening; and a protruding body which is arranged on the support body, the protruding body extends along a circumferential direction to enclose a mounting channel communicated with the mounting opening, and the second muffling block is arranged in the mounting channel; or at least part of the plurality of second passage channels on the support body is opposite to the plurality of muffling channels on the first muffling block; or the support frame includes: a support body which is provided with a mounting opening, a plurality of second passage channels are arranged around the mounting opening; and a protruding body which is arranged on the support body, the protruding body extends along a circumferential direction to enclose a mounting channel communicated with the mounting opening, and the second muffling block is arranged in the mounting channel; at least part of the plurality of second passage channels on the support body is opposite to the plurality of muffling channels on the first muffling block.

In some embodiments, the support frame includes: a support body which is provided with a mounting opening; and a protruding body which is arranged on the support body, the protruding body extends along a circumferential direction to enclose a mounting channel communicated with the mounting opening, and the second muffling block is arranged in the mounting channel; an inner wall surface of the mounting channel is provided with a limiting groove, the limiting groove extends along a circumferential direction of the mounting channel, and the second muffling block is arranged in the limiting groove; or the support frame further includes: a flange which is arranged at an edge of the support body and extends towards a direction away from the protruding body, the flange is arranged around a circumferential direction of the support body, and the first muffling block is arranged on the flange; or an inner wall surface of the mounting channel is provided with a limiting groove, the limiting groove extends along a circumferential direction of the mounting channel, and the second muffling block is arranged in the limiting groove; the support frame further includes: a flange which is arranged at an edge of the support body and extends towards a direction away from the protruding body, the flange is arranged around a circumferential direction of the support body, and the first muffling block is arranged on the flange.

In some embodiments, the support frame is provided with a mounting channel, and the second muffling block is arranged in the mounting channel; and an end of the support frame is provided with a limiting channel communicated with the mounting channel, the limiting channel includes a first end and a second end which are arranged oppositely, the first end of the limiting channel is connected to the mounting channel.

In some embodiments, the sectional area of the radial section of the limiting channel gradually decreases along a direction from the first end to the second end.

In some embodiments, the average inner diameter of the plurality of muffling channels is less than 0.15 mm.

According to a second aspect of the present disclosure, an expansion valve is provided. The expansion valve includes a valve body and a silencing assembly, the valve body is provided with a medium circulation channel, and the silencing assembly is arranged in the medium circulation channel, the silencing assembly is the above silencing assembly.

In some embodiments, the muffling block group and the support frame of the silencing assembly are both mounted in a valve port, and the sectional circulation area of the first passage channel is greater than or equal to ½ of the sectional area of the valve port.

According to a third aspect of the present disclosure, an expansion valve is provided. The expansion valve includes a valve body and a silencing assembly, the valve body is provided with a medium circulation channel, and the silencing assembly is arranged in the medium circulation channel, the silencing assembly is the above silencing assembly, and a valve port channel communicated with the medium circulation channel is arranged in the valve body, the total area of the radial sections of the plurality of second passage channels is S, the minimum sectional area of the radial section of the valve port channel is A, and S ranges from 1.3 A to 2 A.

According to a fourth aspect of the present disclosure, an expansion valve is provided. The expansion valve includes a valve body and a silencing assembly, the valve body is provided with a medium circulation channel, and the silencing assembly is arranged in the medium circulation channel, the silencing assembly is the above silencing assembly, and a valve port channel communicated with the medium circulation channel is also arranged in the valve body; and the first muffling block is arranged close to the valve port channel relative to the second muffling block, and the minimum vertical distance between a plane where the port of the valve port channel is located and the first muffling block is 1-6 mm.

In some embodiments, the medium circulation channel includes a mounting cavity and a mixing cavity which are communicated with each other, and the silencing assembly is arranged in the mounting cavity; a valve port channel is also arranged in the valve body, and the valve port channel is communicated with an end of the mixing cavity away from the mounting cavity; and at least part of the inner wall surface of the mixing cavity is a conical surface or a cylindrical surface.

According to a fifth aspect of the present disclosure, an expansion valve is provided. The expansion valve includes a valve body and a silencing assembly, the valve body is provided with a medium circulation channel, and the silencing assembly is arranged in the medium circulation channel, the silencing assembly is the above silencing assembly, and the minimum inner diameter of the limiting channel is d3; a valve port channel communicated with the medium circulation channel is arranged in the valve body, and the minimum inner diameter of the valve port channel is d2; the first muffling block is provided with the plurality of first passage channels, and the minimum inner diameter of the first passage channel is d1; and d1≥d2, and d3>d1.

According to a sixth aspect of the present disclosure, an air conditioning system is provided. The air conditioning system includes a refrigerant circulation loop and an expansion valve, and the expansion valve is arranged on the refrigerant circulation loop, the expansion valve is the above expansion valve.

According to a seventh aspect of the present disclosure, an air conditioning system is provided. The air conditioning system includes a refrigerant circulation loop and a silencing assembly, and the silencing assembly is arranged on the refrigerant circulation loop, the silencing assembly is the above silencing assembly.

In some embodiments, the air conditioning system further includes: filters which are arranged on the refrigerant circulation loop, the sectional circulation area of the first passage channel in the silencing assembly is greater than the sectional circulation area of a minimum mesh of a filter screen in the filter.

By using the technical solutions of the present disclosure, a silencing assembly includes a muffling block group and a support frame, the muffling block group includes a plurality of muffling channels and at least one first passage channel, and the sectional circulation area of the first passage channel is greater than the minimum sectional circulation area in the plurality of muffling channels; and the support frame is provided with a plurality of second passage channels, the plurality of second passage channels are arranged at intervals, and the muffling block group is arranged on the support frame. By using the plurality of muffling channels in the muffling block group, during the passage of the medium, the noise is reduced. By using the first passage channel and enabling the sectional circulation area of the first passage channel to be greater than the minimum sectional circulation area in the plurality of muffling channels, during the passage of the medium, impurities in the medium are prevented from blocking the muffling block group, and the impurities in the medium can pass through the first passage channel. By cooperation with the second passage channel on the support frame, the silencing effect is ensured, and simultaneously, the situation that the first passage channel in the muffling block group is dirty and blocked is avoided, thereby improving the reliability of the silencing assembly.

### BRIEF DESCRIPTION OF THE DRAWINGS

The accompanying drawings of the specification, constituting a part of the present disclosure, are used for providing a further understanding for the present disclosure. Exemplary embodiments of the present disclosure and descriptions thereof are used for explaining the present disclosure, and do not constitute any improper limitation on the present disclosure. In the accompanying drawings:

FIG. 1 illustrates a schematic structural view of an embodiment of a silencing assembly according to the present disclosure;

FIG. 2 illustrates a schematic structural view of a support frame of a silencing assembly according to the present disclosure;

FIG. 3 illustrates a schematic structural view of a first embodiment of a first muffling block of a silencing assembly according to the present disclosure;

FIG. 4 illustrates a schematic structural view of a second embodiment of a first muffling block of a silencing assembly according to the present disclosure;

FIG. 5 illustrates a mounting schematic view of a first muffling block and a second muffling block of a silencing assembly according to the present disclosure;

FIG. 6 illustrates a sectional view of a second passage channel of a silencing assembly according to the present disclosure;

FIG. 7 illustrates a schematic structural view of an expansion valve according to the present disclosure;

FIG. 8 illustrates an enlarged view of a part A according to FIG. 7;

FIG. 9 illustrates a noise value and a ratio of a flow rate after a silencing filter screen is dirty and blocked to an original flow rate in an expansion valve according to the present disclosure; and

FIG. 10 illustrates a schematic structural view of an air conditioning system according to the present disclosure.

The above accompanying drawings have the following reference numerals:
100. muffling block group; 101. muffling channel; 102. first passage channel; 11. first muffling block; 12. second muffling block; 200. support frame; 201. second passage channel; 20. support body; 202. mounting opening; 21. protruding body; 210. mounting channel; 211. limiting groove; 22. flange; 220. limiting channel; 300. valve body; 400. silencing assembly; 301. medium circulation channel; 3010. mounting cavity; 3011. mixing cavity; 302. valve port channel; 500. refrigerant circulation loop; 501. evaporator; 502. condenser; 600. expansion valve; 700. first filter; 800. second filter.

### DETAILED DESCRIPTION OF THE INVENTION

It should be noted that in the case of no conflict, the embodiments in the present disclosure and the features in the embodiments can be combined with each other. The present disclosure will be described in detail below with reference to the accompanying drawings in conjunction with the embodiments.

It should be noted that the terms used here are only used for describing specific implementations, but are not intended to limit exemplary implementations according to the present disclosure. As used here, unless explicitly stated in the context, the singular form is also intended to include the plural form. In addition, it should also be understood that when the terms “comprising” and/or “including” are used in the specification, they indicate the presence of features, steps, operations, devices, components, and/or combinations thereof.

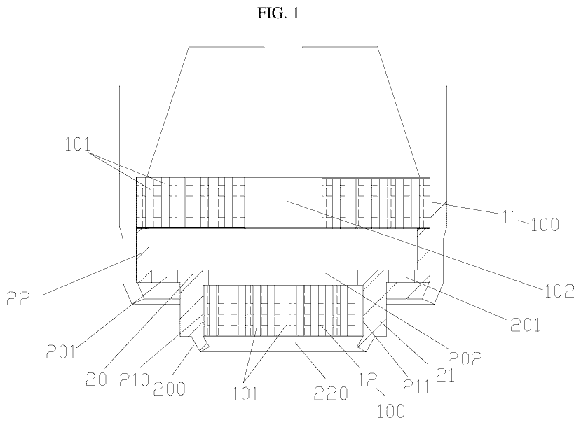

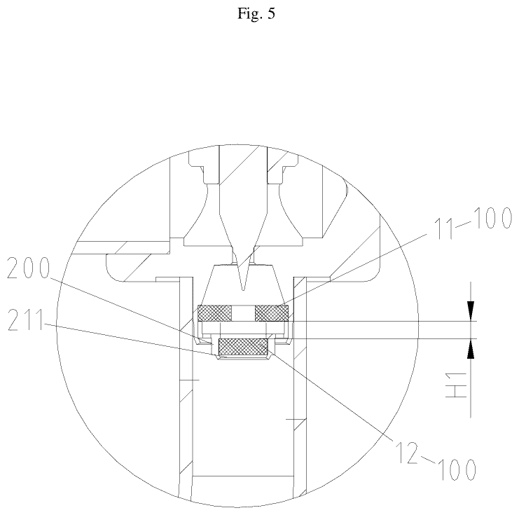

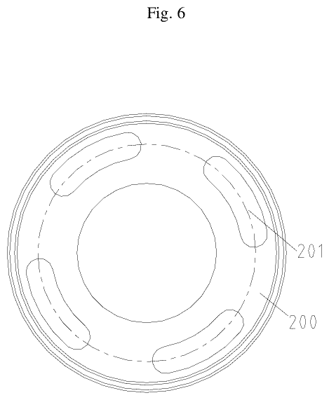

Referring to FIG. 1 to FIG. 6, the present disclosure provides a silencing assembly, comprising a muffling block group 100. The muffling block group 100 includes a plurality of muffling channels 101 and at least one first passage channel 102. The sectional circulation area of the first passage channel 102 is greater than the minimum sectional circulation area in the plurality of muffling channels 101.

By arranging the plurality of muffling channels 101 and the at least one first passage channel 102 on the muffling block group 100 and enabling the sectional circulation area of the first passage channel 102 to be greater than the minimum sectional circulation area in the plurality of muffling channels 101, during the process of medium passing through the muffling block group 100, impurities in the medium can pass through the first passage channel 102 to prevent the impurities in the medium from blocking the muffling channel 101, which affects the silencing effect of the muffling block group 100.

One or a plurality of first passage channels 102 can be provided, and a plurality of muffling channels 101 are provided.

In the first embodiment of the present disclosure, the muffling block group 100 includes a silencing group body, and the at least one first passage channel 102 and the plurality of muffling channels 101 are arranged in the silencing group body. The silencing group body is arranged at a valve port of a valve body, or in a pipeline, or at a position where the valve body and the pipeline are combined, so as to achieve the silencing effect during the process of the medium flowing through the silencing group body. Furthermore, by the arrangement of the first passage channel 102, impurities in the medium can flow downstream to prevent the muffling channel 101 from being blocked, which affects the silencing effect.

In the second embodiment provided in the present disclosure, the muffling block group 100 includes a silencing group body and a support frame 200, the silencing group body is arranged on the support frame 200, the at least one first passage channel 102 is arranged in the support frame 200, and the plurality of muffling channels 101 are arranged in the silencing group body. This arrangement can maximize the silencing effect of the silencing group body. The support frame 200 is arranged separately, and the first passage channel 102 is arranged on the support frame 200, so that impurities in the medium can pass through the first passage channel 102. The silencing group body cooperates with the support frame 200 to achieve the silencing effect and avoid the problem that the muffling channel 101 is blocked by impurities.

In the third embodiment provided in the present invention, the muffling block group 100 further includes: a first muffling block 11 and a second muffling block 12 which are arranged at an interval along a flow direction of a fluid, the first muffling block 11 and the second muffling block 12 are both provided with the plurality of muffling channels 101; and the first muffling block 11 and/or the second muffling block 12 is provided with the at least one first passage channel 102. The minimum vertical distance H1 between the first muffling block 11 and the second muffling block 12 ranges from 0.6 mm to 5 mm. By limiting the value range of the minimum vertical distance between the first muffling block 11 and the second muffling block 12, the pressure drop between the first muffling block 11 and the second muffling block 12 is reduced, the impact on the flow rate is reduced, the situation that bubbles cannot be effectively refined due to a too long distance is avoided, and the silencing effect of the silencing assembly is optimized.

Specifically, the first muffling block 11 includes: multiple layers of first filter screens which are stacked in sequence, the number of layers of the first filter screen is 3-8, and the number of meshes of the first filter screen is 50-90.

Specifically, the second muffling block 12 includes: multiple layers of second filter screens which are stacked in sequence, the number of layers of the second filter screen is 3-8, and the number of meshes of the second filter screen is 50-90.

By limiting the number of layers and the number of meshes of the first filter screen and the second filter screen, the abnormal noise caused by discontinuous flow of large bubbles is reduced, two-phase flow bubbles are refined, and small bubbles are even when flowing through a valve port of an expansion valve, thereby reducing the abnormal noise caused by unstable and discontinuous large bubbles flowing through the valve port.

Here, it should be noted that the number of meshes refers to the number of meshes per square centimeter of area, that is, how many meshes are there per square centimeter of area.

In the fourth embodiment provided in the present disclosure, the muffling block group 100 further includes: a silencing group body, the plurality of first passage channels 102 and the plurality of muffling channels 101 are arranged on the silencing group body; and a support frame 200, the support frame 200 is provided with a plurality of second passage channels 201, the plurality of second passage channels 201 are arranged at intervals, and the muffling block group 100 is arranged on the support frame 200. The silencing assembly in the embodiment according to the present disclosure includes the muffling block group 100 and the support frame 200, the silencing group body of the muffling block group 100 is provided with the plurality of muffling channels 101 and the plurality of first passage channels 102, and the sectional circulation area of the first passage channel 102 is greater than the minimum sectional circulation area in the plurality of muffling channels 101; and the support frame 200 is provided with the plurality of second passage channels 201, the plurality of second passage channels 201 are arranged at intervals, and the muffling block group 100 is arranged on the support frame 200. By using the plurality of muffling channels 101 in the muffling block group 100, during the passage of the medium, the noise is reduced. By using the first passage channel 102 and enabling the sectional circulation area of the first passage channel 102 to be greater than the minimum sectional circulation area in the plurality of muffling channels 101, during the passage of the medium, impurities in the medium are prevented from blocking the muffling block group 100, and the impurities in the medium can pass through the first passage channel 102. By cooperation with the second passage channel 201 on the support frame 200, the silencing effect is ensured, and simultaneously, the situation that the first passage channel 102 in the muffling block group 100 is dirty and blocked is avoided, thereby improving the reliability of the silencing assembly.

Specifically, the silencing group body includes: a first muffling block 11 which is arranged on a first side of the support frame 200; and a second muffling block 12 which is arranged on a second side of the support frame 200. The projection area of an orthographic projection of the first muffling block 11 is greater than the projection area of an orthographic projection of the second muffling block 12, or the orthographic projection of the first muffling block 11 is overlapped with the orthographic projection of the second muffling block 12; the first muffling block 11 and the second muffling block 12 are both provided with the plurality of muffling channels 101; and the first muffling block 11 is provided with the at least one first passage channel 102. During use, when the medium enters or leaves the silencing assembly, bubbles in the medium will be refined into small bubbles by the plurality of muffling channels 101 on the first muffling block 11 and the plurality of muffling channels 101 on the second muffling block 12. Furthermore, the first passage channel 102 is arranged to prevent the plurality of muffling channels 101 from being dirty and blocked completely. In addition, the first muffling block 11 and the second muffling block 12 are sequentially arranged at an interval along an extension direction of a medium circulation channel. In this way, under the combined action of the first muffling block 11 and the second muffling block 12, the medium improves the silencing effect of the silencing assembly.

The orthographic projection refers to a projection of the first muffling block 11 and the second muffling block 12 on a horizontal plane.

The minimum vertical distance between the first muffling block 11 and the second muffling block 12 ranges from 0.6 mm to 5 mm. By limiting the value range of the minimum vertical distance between the first muffling block 11 and the second muffling block 12, the pressure drop between the first muffling block 11 and the second muffling block 12 is reduced, the impact on the flow rate is reduced, the situation that bubbles cannot be effectively refined due to a too long distance is avoided, and the silencing effect of the silencing assembly is optimized.

Specifically, the first muffling block 11 includes: multiple layers of first filter screens which are stacked in sequence, the number of layers of the first filter screen is 3-8, and the number of meshes of the first filter screen is 50-90.

Specifically, the second muffling block 12 includes: multiple layers of second filter screens which are stacked in sequence, the number of layers of the second filter screen is 3-8, and the number of meshes of the second filter screen is 50-90. The orthographic projection refers to a projection of the first muffling block 11 and the second muffling block 12 on a horizontal plane.

In a specific implementation process, the first muffling block 11 is provided with the at least one first passage channel 102, and at least part of the first passage channel 102 on the first muffling block 11 is opposite to the plurality of muffling channels 101 on the second muffling block 12. Due to this arrangement, during the flow of the medium, when the medium flows through the plurality of muffling channels 101, if there are too many impurities in the medium, a part of impurities will remain on the second muffling block 12, and the other part of impurities will flow out through the plurality of first passage channels 102 on the first muffling block 11. In this way, the situation that the muffling channels 101 on both the first muffling block 11 and the second muffling block 12 are dirty and blocked is avoided, thereby preventing the silencing effect from being affected. When the medium flows in an opposite direction, the impurities remaining on the second muffling block 12 can be directly carried away.

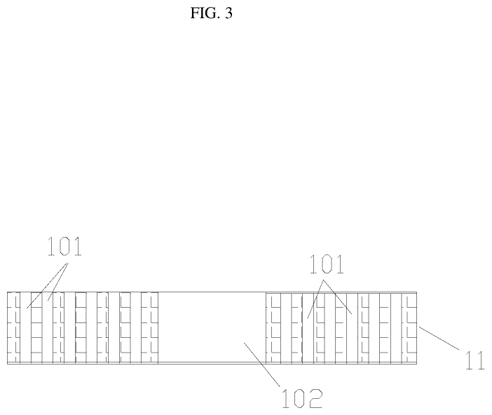

In the first embodiment of the first muffling block 11 of the present disclosure, as shown in FIG. 3, the first passage channel 102 is arranged at the middle part of the first muffling block 11, and at this time, the muffling channel 101 on the second muffling block 12 is arranged at the middle part of the second muffling block 12.

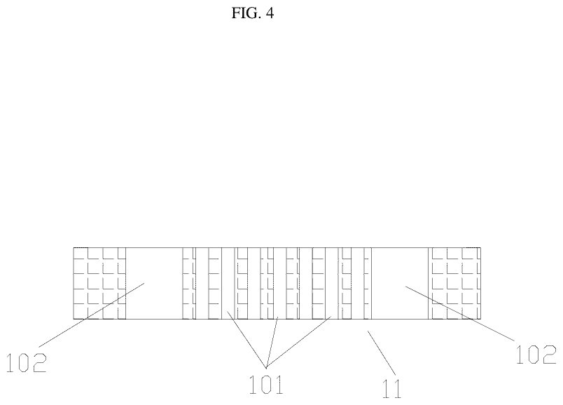

In the second embodiment of the first muffling block 11 of the present disclosure, as shown in FIG. 4, the plurality of first passage channels 102 are arranged at an edge of the first muffling block 11, and at this time, the muffling channel 101 on the second muffling block 12 is arranged at an edge of the second muffling block 12.

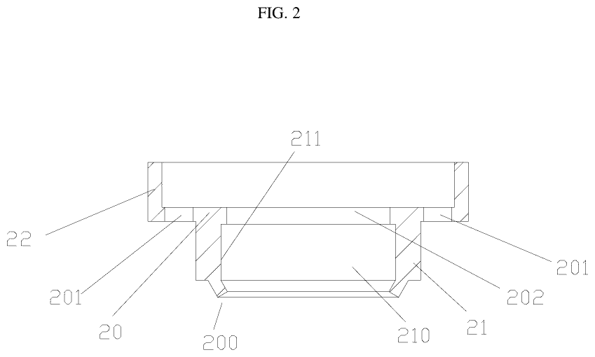

In the embodiment provided in the present disclosure, as shown in FIG. 2, the support frame 200 includes: a support body 20 which is provided with a mounting opening 202, a plurality of second passage channels 201 are arranged around the mounting opening 202; and a protruding body 21 which is arranged on the support body 20, the protruding body 21 extends along a circumferential direction to enclose a mounting channel 210 communicated with the mounting opening 202, and the second muffling block 12 is arranged in the mounting channel 210. During the flow of the medium, a part of the medium is silenced by the muffling channel 101 on the second muffling block 12, and the other part of the medium flows to the muffling channel 101 on the first muffling block 11 by the second passage channel 201 on the support body 20 to achieve the silencing effect. Furthermore, impurities in the medium can be attached to the first muffling block 11 directly by the second passage channel 201. When the medium flows in an opposite direction, the impurities on the first muffling block 11 are carried away and flow out by the second passage channel 201 on the support body 20, thereby ensuring the silencing effect, and achieving a cleaning effect on the first muffling block 11 and the second muffling block 12.

Specifically, at least part of the plurality of second passage channels 201 on the support body 20 are opposite to the plurality of muffling channels 101 on the first muffling block 11. Due to a poor silencing ability of the second passage channel 201 on the medium compared to the muffling channel 101, by enabling at least part of the plurality of second passage channels 201 on the support body 20 to be opposite to the plurality of muffling channels 101 on the first muffling block 11, after the medium flows through the second passage channel 201, the muffling channel 101 on the first muffling block 11 is used for silencing immediately to avoid excessive noise.

For the convenience of mounting the second muffling block 12, an inner wall surface of the mounting channel 210 is provided with a limiting groove 211, the limiting groove 211 extends along a circumferential direction of the mounting channel 210, and the second muffling block 12 is arranged in the limiting groove 211. In this way, the second muffling block 12 is stopped by two opposite groove wall surfaces of the limiting groove 211 to maintain the stability when the second muffling block 12 is impacted by the medium.

In a specific implementation process, the support frame 200 further includes: a flange 22 which is arranged at an edge of the support body 20 and extends towards a direction away from the protruding body 21, the flange 22 is arranged around a circumferential direction of the support body 20, and the first muffling block 11 is arranged on the flange 22. By arranging the flange 22, a gap is formed between the first muffling block 11 and the support body 20, and the gap achieves a buffering effect on the medium, thereby preventing the medium from directly impacting the support body 20 after flowing through the first muffling block 11 or directly impacting the first muffling block 11 after flowing through the support body 20, which can cause larger energy loss in the medium and affect the operation of the entire medium circulation system. Preferably, the distance between a connecting end surface of the first muffling block 11 and an end surface of the mounting opening 202 enclosed by the support body 20 (namely the height of the flange 22) is 0.2-3 mm, preferably 0.8 mm, thereby ensuring that the distance between the first muffling block 11 and the second muffling block 12 achieves an optimal noise reduction effect.

Preferably, the average inner diameter of the plurality of muffling channels 101 is less than 0.15 mm. In this way, bubbles in the medium are refined evenly to improve the silencing effect.

The silencing assembly in the present disclosure can be fixed on a valve body component, or in a pipe, or at a joint between a pipe and a valve body. During the process of the medium passing through the silencing assembly, the silencing assembly can achieve the silencing effect. By the combined action of the first muffling block 11 and the second muffling block 12, the noise reduction effect is optimized. Furthermore, since the first passage channel 102 and the second passage channel 201 are arranged, the impact of the pressure on the medium caused by the first passage channel 102 and the second passage channel 201 as well as the impact on noise reduction can be compensated, and the problem that the muffling channel 101 is easily blocked by impurities in the medium is also solved.

In a specific implementation process, the support frame 200 is provided with a mounting channel 210, and the second muffling block 12 is arranged in the mounting channel 210; and an end of the support frame 200 is provided with a limiting channel 220 communicated with the mounting channel 210, the limiting channel 220 includes a first end and a second end which are arranged oppositely, the first end of the limiting channel 220 is connected to the mounting channel 210, and the sectional area of the radial section of the limiting channel 220 gradually decreases along a direction from the first end to the second end. The radial section of the limiting channel 220 is circular. The second muffling block 12 is limited by the limiting channel 220, thereby reducing the number of components, and simplifying the overall structure and assembly process.

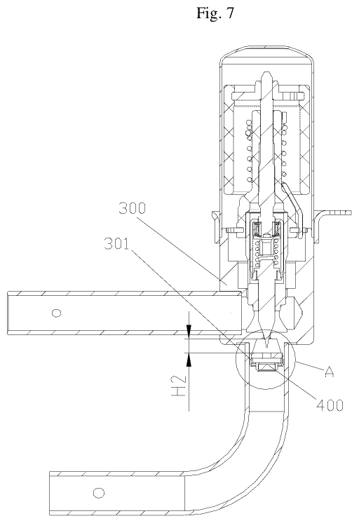

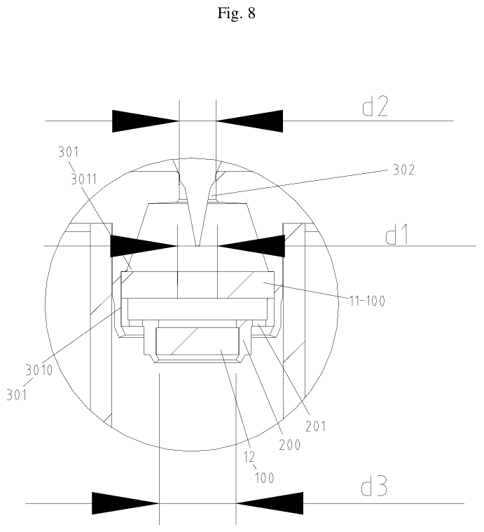

As shown in FIG. 7 and FIG. 8, the present disclosure further provides an expansion valve, comprising a valve body 300 and a silencing assembly 400. The valve body 300 is provided with a medium circulation channel 301, and the silencing assembly 400 is arranged in the medium circulation channel 301, the silencing assembly is the above silencing assembly.

A valve port is arranged in the valve body 300, the muffling block group 100 and the support frame 200 are both mounted in the valve port, and the sectional circulation area of the first passage channel 102 is greater than or equal to ½ of the sectional area of the valve port. The sectional circulation area of the second passage channel 201 is greater than or equal to ½ of the sectional area of the valve port, thereby preventing the inside of the muffling channel 101 from being dirty and blocked, and avoiding significant pressure drop during the process of the medium passing through the first passage channel 102 or the second passage channel 201.

A valve port channel 302 communicated with the medium circulation channel 301 is arranged in the valve body 300, the total area of the radial sections of the plurality of second passage channels 201 is S, the minimum sectional area of the radial section of the valve port channel 302 is A, and S ranges from 1.3 A to 2 A. This arrangement ensures that the fully open flow rate of the expansion valve does not decay, does not affect the refining effect of bubbles, and achieves the noise reduction effect of reducing the two-phase flow in front of the valve. By designing the second passage channel 201 with a larger size, the flow rate can still be adjusted normally in a case that the filter screen is blocked.

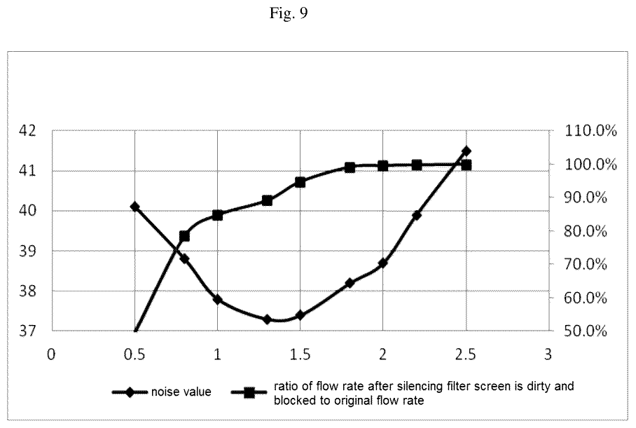

FIG. 9 shows a noise value and a ratio of a flow rate after a silencing filter screen (first muffling block and second muffling block) is dirty and blocked to an original flow rate. The relationship among a ratio of a total area S to a minimum sectional area A, a noise value and a ratio of a flow rate after a silencing filter screen is dirty and blocked to an original flow rate is shown in the following table:

| Ratio of total area | | Ratio of flow rate after |
|---|---|---|
| S to minimum sectional | Noise | silencing filter screen is dirty and |
| area A | value | blocked to original flow rate |
| 0.5 | 40.1 | 49.5% |
| 0.8 | 38.8 | 78.4% |
| 1 | 37.8 | 84.7% |
| 1.3 | 37.3 | 89.1% |
| 1.5 | 37.4 | 94.7% |
| 1.8 | 38.2 | 99.1% |
| 2 | 38.7 | 99.5% |
| 2.2 | 39.9 | 99.7% |
| 2.5 | 41.5 | 99.9% |

A valve port channel 302 communicated with the medium circulation channel 301 is also arranged in the valve body 300; and the first muffling block 11 is arranged close to the valve port channel 302 relative to the second muffling block 12, and the minimum vertical distance H2 between a plane where the port of the valve port channel 302 is located and the first muffling block 11 is 1-6 mm. Further, the medium circulation channel 301 includes a mounting cavity 3010 and a mixing cavity 3011 which are communicated with each other, and the silencing assembly 400 is arranged in the mounting cavity 3010; a valve port channel 302 is also arranged in the valve body 300, and the valve port channel 302 is communicated with an end of the mixing cavity 3011 away from the mounting cavity 3010; and at least part of the inner wall surface of the mixing cavity 3011 is a conical surface or a cylindrical surface. This arrangement can reduce the decay of the flow rate, meet the requirements of the system for the flow rate under a large opening degree, and enable the bubbles flowing through the first muffling block 11 and the second muffling block 12 to be repeatedly mixed evenly, thereby avoiding abnormal noise due to insufficient mixing and uneven bubble size distribution caused by too close distance, and also avoiding abnormal noise due to the formation of large bubbles again by the mutual combination of refined small bubbles caused by too far distance.

The silencing assembly is the silencing assembly in the above embodiment, and the minimum inner diameter of the limiting channel 220 is d3; a valve port channel 302 communicated with the medium circulation channel 301 is arranged in the valve body 300, and the minimum inner diameter of the valve port channel 302 is d2; the first muffling block 11 is provided with the plurality of first passage channels 102, and the minimum inner diameter of the first passage channel 102 is d1; and d1> d2, and d3>d1. This arrangement avoids the impact on the flow rate due to throttling caused by a center hole of the filter screen after the filter screen is dirty and blocked, and prevents large bubbles flowing through the center hole from flowing out by a bypass hole or prevents large bubbles flowing through the bypass hole from flowing out by the bypass hole, thereby avoiding abnormal noise caused by uneven refinement of bubbles. Here, it should be noted that the radial section of the limiting channel 220 is circular, the radial section of the valve port channel 302 is circular, and the radial sections of both the first passage channel 102 and the second passage channel 201 are circular.

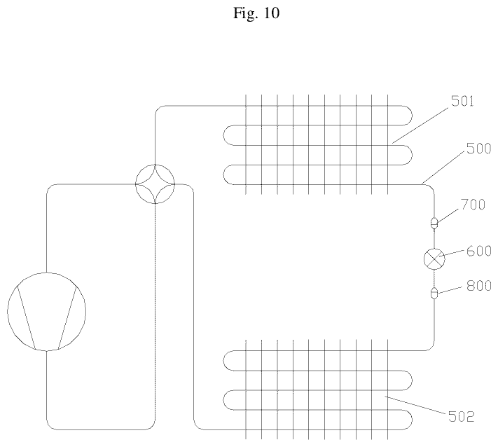

As shown in FIG. 10, the present disclosure further provides an air conditioning system, comprising a refrigerant circulation loop 500 and an expansion valve 600. The expansion valve 600 is arranged on the refrigerant circulation loop 500, and the expansion valve 600 is the above expansion valve 600.

The present disclosure further provides an air conditioning system, comprising a refrigerant circulation loop 500 and a silencing assembly. The silencing assembly is arranged on the refrigerant circulation loop 500, and the silencing assembly is the silencing assembly in the above embodiment.

The air conditioning system further includes filters. The filters are arranged on the refrigerant circulation loop 500, and the sectional circulation area of the first passage channel 102 in the silencing assembly is greater than the sectional circulation area of a minimum mesh of a filter screen in the filter.

Specifically, the filters include a first filter 700 and a second filter 800. The first filter 700 and the second filter 800 are arranged at an interval on the refrigerant circulation loop 500, and the expansion valve 600 is located between the first filter 700 and the second filter 800. The refrigerant circulation loop 500 is also provided with an evaporator 501 and a condenser 502. In a practical disclosure process, a two-phase refrigerant circulates in the refrigerant circulation loop 500. During the process of the refrigerant passing through the expansion valve 600, bubbles in the refrigerant are refined by the muffling channels 101 in the first muffling block 11 and the second muffling block 12 in the silencing assembly to achieve the silencing effect. Furthermore, since the first passage channel 102 and the second passage channel 201 are arranged, the situation that the muffling channel 101 is blocked by impurities in the refrigerant can be avoided. After the impurities which are not filtered in the first filter 700 pass through the first passage channel 102 and the second passage channel 201, the impurities can be further filtered by the second filter 800, thereby improving the operation reliability of the air conditioning system. In a case that the muffling channel 101 is blocked by the impurities, when the refrigerant flows in an opposite direction, the impurities in the muffling channel 101 can be carried away to achieve the cleaning effect to delay the dirtying and blocking time.

From the above description, it can be seen that the above embodiments of the present disclosure achieve the following technical effects:

The silencing assembly provided in the present disclosure includes the muffling block group 100 and the support frame 200, the muffling block group 100 includes the plurality of muffling channels 101 and the at least one first passage channel 102, and the sectional circulation area of the first passage channel 102 is greater than the minimum sectional circulation area in the plurality of muffling channels 101; and the support frame 200 is provided with the plurality of second passage channels 201, the plurality of second passage channels 201 are arranged at intervals, and the muffling block group 100 is arranged on the support frame 200. By using the plurality of muffling channels 101 in the muffling block group 100, during the passage of the medium, the noise is reduced. By using the first passage channel 102 and enabling the sectional circulation area of the first passage channel 102 to be greater than the minimum sectional circulation area in the plurality of muffling channels 101, during the passage of the medium, impurities in the medium are prevented from blocking the muffling block group 100, and the impurities in the medium can pass through the first passage channel 102. By cooperation with the second passage channel 201 on the support frame 200, the silencing effect is ensured, and simultaneously, the situation that the first passage channel 102 in the muffling block group 100 is dirty and blocked is avoided, thereby improving the reliability of the silencing assembly.

It should be noted that the terms “first”, “second”, etc. in the specification, claims and accompanying drawings of the present application are used to distinguish similar objects, but are not intended to describe a particular sequence or a precedence order. It should be understood that the data used in this way can be interchanged in appropriate circumstances, so that the implementations of the present application described here can be implemented in a sequence other than those illustrated or described here. In addition, the terms “include” and “have” and any variants thereof are intended to cover non-exclusive inclusion. For example, a process, method, system, product, or device that includes a series of steps or units is not necessarily limited to those steps or units that are clearly listed, but can include other steps or units not clearly listed or inherent to such process, method, product, or device.

For ease of description, spatial relative terms such as “above”, “over”, “on the upper surface of” and “on the top of” can be used here to describe the spatial positional relationship between a device or feature and other devices or features as shown in the figures. It should be understood that the spatial relative terms are intended to include different orientations in use or operation other than the orientations of the devices described in the figures. For example, if a device in the figures is inverted, the device described as “over another device or structure” or “above another device or structure” will be then positioned as “under another device or structure” or “below another device or structure”. Therefore, the exemplary term “over” can include two orientations: “over” and “under”. The device can also be positioned in other different modes (rotated 90 degrees or in other orientations), and the spatial relative description used here is explained accordingly.

The above descriptions are only preferred embodiments of the present disclosure, but are not intended to limit the present disclosure. It will be apparent to those skilled in the art that various modifications and changes can be made in the present disclosure. Any modifications, equivalent replacements, improvements, and the like made within the spirit and principle of the present disclosure shall be included within the protection scope of the present disclosure.

1. A silencing assembly, wherein comprising:
a muffling block group, the muffling block group comprises a plurality of muffling channels and at least one first passage channel, and the sectional circulation area of the first passage channel is greater than the minimum sectional circulation area in the plurality of muffling channels.

2. The silencing assembly as claimed in claim 1, wherein the muffling block group comprises a silencing group body, and the at least one first passage channel and the plurality of muffling channels are disposed on the silencing group body.

3. The silencing assembly as claimed in claim 1, wherein the muffling block group comprises a silencing group body and a support frame, the silencing group body is disposed on the support frame, the at least one first passage channel is disposed on the support frame, and the plurality of muffling channels are disposed on the silencing group body.

4. The silencing assembly as claimed in claim 1, wherein the muffling block group further comprises:
a first muffling block and a second muffling block which are disposed at an interval along a flow direction of a fluid, and the plurality of muffling channels are disposed on both the first muffling block and the second muffling block; the at least one first passage channel is disposed on the first muffling block; or the at least one first passage channel is disposed on the second muffling block; or the at least one first passage channel is disposed on the first muffling block and at least another first passage channel is disposed on the second muffling block.

5. The silencing assembly as claimed in claim 4, wherein the first muffling block comprises:
multiple layers of first filter screens which are stacked in sequence;
the number of layers of the first filter screen is 3-8, and the number of meshes of the first filter screen is 50-90.

6. The silencing assembly as claimed in claim 4, wherein the second muffling block comprises:
multiple layers of second filter screens which are stacked in sequence;
the number of layers of the second filter screen is 3-8, and the number of meshes of the second filter screen is 50-90.

7. The silencing assembly as claimed in claim 1, wherein the muffling block group further comprises:
a silencing group body, the plurality of muffling channels and the at least one first passage channel are disposed on the silencing group body; and
a support frame, a plurality of second passage channels are disposed on the support frame, the plurality of second passage channels are disposed at intervals, and the silencing group body is disposed on the support frame.

8. The silencing assembly as claimed in claim 7, wherein the radial section of the second passage channel extends along an arc trajectory; or
the radial section of the second passage channel is circular; or
the silencing group body comprises:
a first muffling block, disposed on a first side of the support frame, and
a second muffling block, disposed on a second side of the support frame,
the plurality of muffling channels are disposed on both the first muffling block and the second muffling block; and the at least one first passage channel is disposed on the first muffling block.

9. (canceled)

10. The silencing assembly as claimed in claim 1, wherein the muffling block group comprises a silencing group body and a support frame, and the silencing group body comprises:
a first muffling block, disposed on a first side of the support frame, and
a second muffling block, disposed on a second side of the support frame,
the plurality of muffling channels are disposed on both the first muffling block and the second muffling block; and the at least one first passage channel is disposed on the first muffling block; the at least one first passage channel is disposed on the first muffling block and at least part of each of the first passage channels on the first muffling block is disposed opposite to the plurality of muffling channels on the second muffling block.

11. The silencing assembly as claimed in claim 1, wherein the muffling block group comprises a silencing group body and a support frame, and the silencing group body comprises:
a first muffling block, disposed on a first side of the support frame, and
a second muffling block, disposed on a second side of the support frame,
the plurality of muffling channels are disposed on both the first muffling block and the second muffling block; and the at least one first passage channel is disposed on the first muffling block; the support frame comprises:
a support body, a mounting opening is disposed on the support body, a plurality of second passage channels are disposed around the mounting opening; and
a protruding body, disposed on the support body, the protruding body extends along a circumferential direction to enclose a mounting channel which is communicated with the mounting opening, and the second muffling block is disposed in the mounting channel; or
at least part of the plurality of second passage channels on the support body are disposed opposite to the plurality of muffling channels on the first muffling block; or
the support frame comprises:
a support body, a mounting opening is disposed on the support body, a plurality of second passage channels are disposed around the mounting opening; and
a protruding body, disposed on the support body, the protruding body extends along a circumferential direction to enclose a mounting channel which is communicated with the mounting opening, and the second muffling block is disposed in the mounting channel;
at least part of the plurality of second passage channels on the support body are disposed opposite to the plurality of muffling channels on the first muffling block.

12. (canceled)

13. The silencing assembly as claimed in claim 11, wherein the support frame comprises:
a support body, a mounting opening is disposed on the support body, and
a protruding body, disposed on the support body, wherein the protruding body extends along a circumferential direction to enclose a mounting channel which is communicated with the mounting opening, and the second muffling block is disposed in the mounting channel; and
a limiting groove is disposed on an inner wall surface of the mounting channel, the limiting groove extends along a circumferential direction of the mounting channel, and the second muffling block is disposed in the limiting groove; or
the support frame further comprises:
a flange, disposed on an edge of the support body and extends towards a direction away from the protruding body, the flange is disposed around a circumferential direction of the support body, and the first muffling block is disposed on the flange; or
the support frame comprises:
a support body, a mounting opening is disposed on the support body, and
a protruding body, disposed on the support body, wherein the protruding body extends along a circumferential direction to enclose a mounting channel which is communicated with the mounting opening, and the second muffling block is disposed in the mounting channel; and
a limiting groove is disposed on an inner wall surface of the mounting channel, the limiting groove extends along a circumferential direction of the mounting channel, and the second muffling block is disposed in the limiting groove;
the support frame further comprises:
a flange, disposed on an edge of the support body and extends towards a direction away from the protruding body, the flange is disposed around a circumferential direction of the support body, and the first muffling block is disposed on the flange.

14. (canceled)

15. The silencing assembly as claimed in claim 91, wherein a mounting channel is disposed on the support frame, and a second muffling block is disposed in the mounting channel; and
a limiting channel which is communicated with the mounting channel is disposed on an end of the support frame, the limiting channel comprises a first end and a second end which are disposed oppositely, and the first end of the limiting channel is connected with the mounting channel.

16. The silencing assembly as claimed in claim 1, wherein the average inner diameter of the plurality of muffling channels is less than 0.15 mm.

17. An expansion valve, comprising a valve body and a silencing assembly, a medium circulation channel being disposed on the valve body, and the silencing assembly being disposed in the medium circulation channel, wherein the silencing assembly is the silencing assembly as claimed in claim 1.

18. The expansion valve as claimed in claim 17, wherein a valve port is disposed in the valve body, the muffling block group and the support frame of the silencing assembly are both disposed in the valve port, and the sectional circulation area of the first passage channel is greater than or equal to ½ of the sectional area of the valve port.

19. An expansion valve, comprising a valve body and a silencing assembly, a medium circulation channel being disposed on the valve body, and the silencing assembly being disposed in the medium circulation channel, wherein the silencing assembly is the silencing assembly as claimed in claim 7, and a valve port channel which is communicated with the medium circulation channel is disposed in the valve body; and
the total area of the radial sections of the plurality of second passage channels is S, the minimum sectional area of the radial section of the valve port channel is A, and S ranges from 1.3 A to 2 A.

20. An expansion valve, comprising a valve body and a silencing assembly, a medium circulation channel being disposed on the valve body, and the silencing assembly being disposed in the medium circulation channel, wherein the silencing assembly is the silencing assembly as claimed in claim 4, and a valve port channel which is communicated with the medium circulation channel is also disposed in the valve body; and
the first muffling block is disposed close to the valve port channel relative to the second muffling block, and the minimum vertical distance between a plane where the port of the valve port channel is located and the first muffling block is 1-6 mm.

21. The expansion valve as claimed in claim 17, wherein the medium circulation channel comprises a mounting cavity and a mixing cavity which are communicated with each other, and the silencing assembly is disposed in the mounting cavity;
a valve port channel is also disposed in the valve body, and the valve port channel is communicated with an end of the mixing cavity away from the mounting cavity; and
at least part of the inner wall surface of the mixing cavity is a conical surface or a cylindrical surface.

22. An expansion valve, comprising a valve body and a silencing assembly, a medium circulation channel being disposed on the valve body, and the silencing assembly being disposed in the medium circulation channel, wherein the silencing assembly is the silencing assembly as claimed in claim 15, and the minimum inner diameter of the limiting channel is d3;
a valve port channel which is communicated with the medium circulation channel is disposed in the valve body, and the minimum inner diameter of the valve port channel is d2;
the plurality of first passage channels is disposed on the first muffling block, and the minimum inner diameter of the first passage channel is d1; and
d1≥d2, and d3>d1.

23. An air conditioning system, comprising a refrigerant circulation loop and an expansion valve, the expansion valve being disposed on the refrigerant circulation loop, wherein the expansion valve is the expansion valve as claimed in claim 17.

24. An air conditioning system, comprising a refrigerant circulation loop and an expansion valve, the expansion valve being disposed on the refrigerant circulation loop, wherein the expansion valve is the expansion valve as claimed in claim 1.

25. The air conditioning system as claimed in claim 24, wherein the air conditioning system further comprises:
a filter, disposed on the refrigerant circulation loop, he sectional circulation area of the first passage channel in the silencing assembly is greater than the sectional circulation area of a minimum mesh of a filter screen in the filter.

26. The silencing assembly as claimed in claim 4, wherein a minimum vertical distance between the first muffling block and the second muffling block ranges from 0.6 mm to 5 mm.

27. The silencing assembly as claimed in claim 15, wherein the sectional area of the radial section of the limiting channel gradually decreases along a direction from the first end to the second end of the limiting channel.
